(19) United States
(12) Patent Application Publication
(10) Pub. No.: US 2005/0083475 A1
(43) Pub. Date: Apr. 21, 2005

(54) Liquid crystal display device

(76) Inventor: Chin-Hung Hsu, Yang Mei Town (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/901,787

(22) Filed: Jul. 29, 2004

(30) Foreign Application Priority Data
Oct. 21, 2003 (TW) 92129199

(51) Int. Cl. G02F 1/1345

(52) U.S. Cl. 349/152

(57) ABSTRACT

The present invention provides a conductive line structure of a liquid crystal display. In accordance with this structure, the conductive lines in the present invention are all arranged in the FPC board and the glass substrate. Therefore, the required area of the PCB can be reduced, which also reduce the volume ands weight of the LCD.

### FIELD OF THE INVENTION

The present invention relates to a liquid crystal display and more particularly to a liquid crystal display with narrow frame area by reducing the non-display area.

### BACKGROUND OF THE INVENTION

With the merits of small volume and lightweight, liquid crystal display (LCD) holds the edge in the market for portable display devices and small-space application displays. Among all, the thin film transistor liquid crystal display (TFT-LCD) is the preferred device. A TFT-LCD uses field effect transistors to control the voltage applied to the liquid crystal film layer so as to control the orientation of liquid crystal molecules, thus adjusting the penetration of light through the liquid crystal layer. With the utilization of filters, a screen is able to display various colors and degrees if brightness.

FIG. 1 illustrates the schematic diagram of a conventional liquid crystal display, which comprises a liquid crystal panel 100 for displaying the image, Y-direction driver integrated circuit (IC) chips 104, X-direction driver integrated circuit (IC) chips 106, a Y-direction printed circuit board (Y-PCB) 102 and an X-direction printed circuit board (X-PCB) 108. The PCBs 102 and 108 are used to process the electrical signal. The driver IC chips 104 and 106 are located on a first flexible printed circuit (FPC). The first FPC board can be a tape carrier package (TCP) or a chip on film (COF). Anisotropic conductive films (ACFs) are used for fine pitch interconnections between the liquid crystal panel 100, the PCBs 102 and 108 and the driver IC chips 104 and 106. And the X-PCB 108 and the Y-PCB 102 are connected by another FPC board 110.

Typically, no matter signals from the X-PCB 108 and Y-PCB 102 all are transferred to the FPC boards with the drivers IC chip 104 and 106. Such transferring structure requires a large space to contain all conductive line, which is a challenge when the scale of the LCD is reduced.

### SUMMARY OF THE INVENTION

In accordance with the foregoing description, the typical LCD structure always requires an additional PCB for circuit layout. Such structure not only requires a large space but also increases the manufacturing cost. Therefore, it is the main object of the present invention to provide a conductive line structure of a liquid crystal display with a smaller PCB area, which means the non-display area is reduced. Therefore, the whole volume of the liquid crystal display can be reduced.

Another purpose of the present invention is to provide a conductive line structure of a liquid crystal display. All conductive lines are arranged on a FPC board and glass substrate to reduce the required PCB area.

Yet another purpose of the present invention is to provide a structure of a driver IC. A regulator is added to a driver IC to provide a stable output voltage to avoid aliasing.

The present invention provides a conductive line structure of a liquid crystal display, which comprises a liquid crystal panel for displaying the image, a glass substrate, Y-direction driver integrated circuit (IC) chips, X-direction driver integrated circuit (IC) chips, a Y-direction printed circuit board (Y-PCB) and an X-direction printed circuit board (X-PCB). The PCBs and are used to process the electrical signal. The driver IC chips are located on a first flexible printed circuit (FPC). The first FPC board can be a tape carrier package (TCP) or a chip on film (COF). The conductive lines in the present invention are all arranged in the first FPC board and the glass substrate to reduce the required area of the PCB. In other words, a liquid crystal display with a narrow frame area can be obtained by reducing the non-display area. Therefore, the volume and the weight of the liquid crystal display can be improved.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a schematic diagram of a conventional liquid crystal display;

FIG. 2 illustrates a schematic diagram of a liquid crystal display according to the first embodiment of the present invention;

FIG. 3 illustrates a schematic diagram of a conductive lines arrangement according to the first embodiment of the present invention;

FIG. 4A illustrates a schematic diagram of a driver IC according to the preferred embodiment of the present invention;

FIG. 4B illustrates a schematic diagram of a driver IC according to another preferred embodiment of the present invention;

FIG. 5 illustrates a schematic diagram of a liquid crystal display according to the second embodiment of the present invention; and

FIG. 6 illustrates a schematic diagram of a conductive lines arrangement according to the second embodiment of the present invention.

### DETAILED DESCRIPTION OF THE PREFERRED EMBODIMENT

Without limiting the spirit and scope of the present invention, the conductive line structure of a liquid crystal display proposed in the present invention is illustrated with one preferred embodiment. One with ordinary skill in the art, upon acknowledging the embodiment, can apply the conductive line structure of the present invention to various liquid crystal displays. The conductive lines in the present invention are all arranged in the FPC board and the glass substrate. Therefore, the areas of the PCB can be reduced. Additionally, a regulator is added to a driver IC to provide a stable output voltage and thus avoid aliasing. The application of the present invention is not limited by the preferred embodiments described in the following.

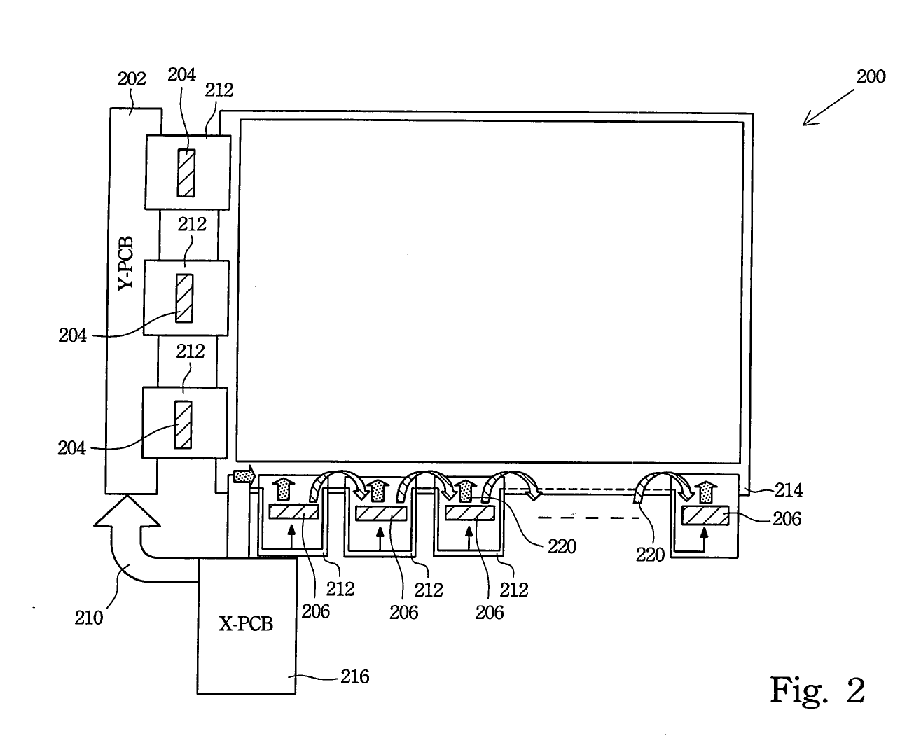

FIG. 2 illustrates a schematic diagram of a liquid crystal display according to the first embodiment of the present invention, which comprises a liquid crystal panel 200 located on a glass substrate 214 for displaying the image, Y-direction driver integrated circuit (IC) chips 204, X-direction driver integrated circuit (IC) chips 206, a Y-direction printed circuit board (Y-PCB) 202 and an X-direction printed circuit board (X-PCB) 216. The PCBs 202 and 216 are used to process the electrical signal. The driver IC chips 204 and 206 are located on a flexible printed circuit (FPC) 212. The FPC board 212 can be a tape carrier package (TCP) or a chip on film (COF). An another printed circuit board 210 is used to connect the PCBs 202 and 216. The another printed circuit board 210 is a flexible printed circuit film.

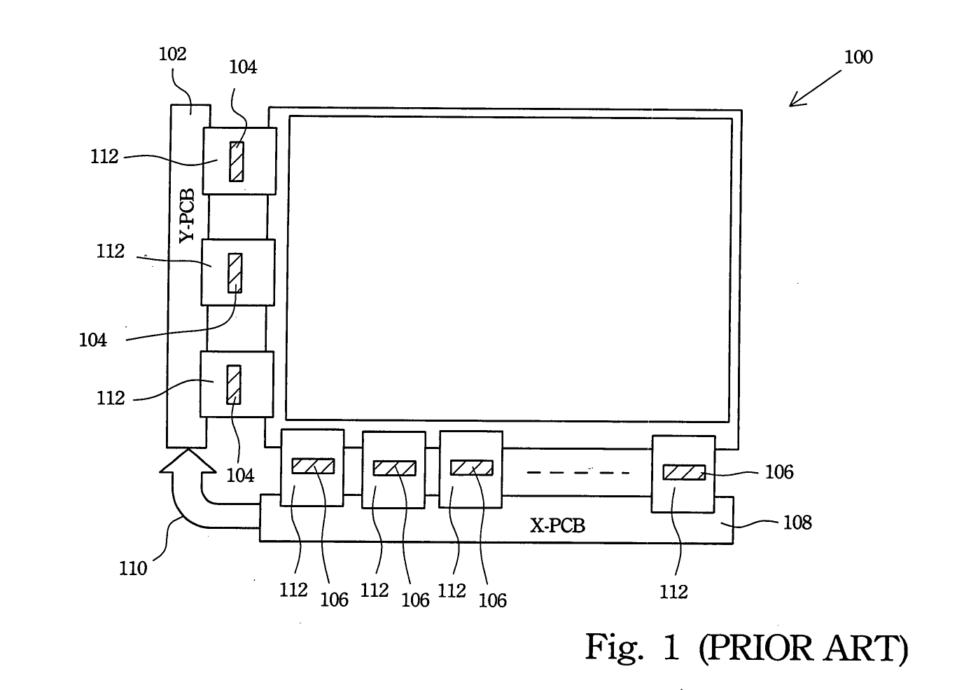

The conductive lines in the conventional structure are arranged in the X-direction PCB 108 as illustrated in the FIG. 1. However, the conductive lines in the present invention are arranged in the FPC boards 212 and the glass substrate 214 as illustrated in the FIG. 2. Therefore, the area of the X-direction PCB 216 can be reduced. In other words, the whole volume of the liquid crystal display can be further reduced by the area reduction of the X-direction PCB 216. Anisotropic conductive films (ACFs) are used for fine pitch interconnections between the liquid crystal panel 200, the FPC boards 212 and the glass substrate 214.

On the other hand, when a signal is transferred form the X-direction PCB 216, this signal also passes the FPC board 210 to the Y-direction PCB 202. In other words, the conductive lines are arranged from the X-direction PCB 216 and through the FPC board 210 to the Y-direction PCB 202.

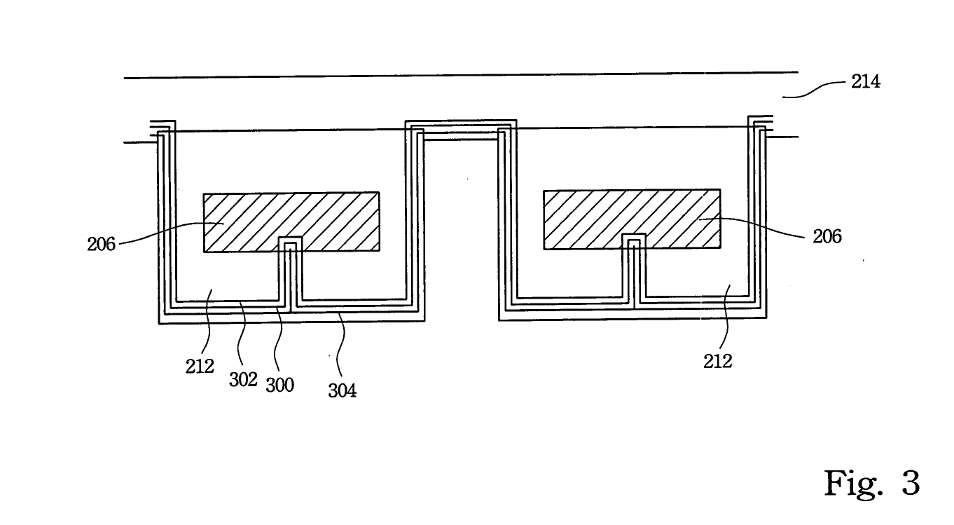

FIG. 3 illustrates a schematic diagram of a conductive lines arrangement according to the preferred embodiment of the present invention. These conductive lines comprise a gamma power circuit 304, a voltage drain drain 302 (VDD) and a ground circuit 300 (GND). These conductive line are arranged in the plurality of PCBs 212 and the glass substrate 214. They are electrically connected to the driver IC chips 206. Each driver IC 206 is coupled with a signal line (not shown in this figure) for transferring the driving signal 220, as illustrated in the FIG. 2, from the driver IC. These driver ICs 210 are arranged in series. It is noted that other types of circuit layout can be used in the present invention.

According to the present inveniton, the power is sequentially transferred to the X-direction driver IC chips 206. In other words, after the power is transferred from the X-direction PCB 216, this power is sent to the X-direction driver IC chips 206, one by one.

Reference is made to FIG. 2 again. The driving signal 220 in the X direction is sequentially transferred to the X-direction driver IC chips 206 for controlling an image display in the panel. It is noticed that the conductive lines arrangement can be used in the Y-direction to remove the Y-direction PCB 202.

On the other hand, the conductive lines for sequentially transferring power to the X-direction driver IC chips 206 are arranged in the FPC board 212 and the glass substrate 214 according to the present inveniton. However, the large resistance of the glass substrate can degrade the power, resulting in a different power being supplied to each driver IC 206, which causes aliasing. Therefore, an additional regulator is added to the driver IC to ensure a stable output voltage.

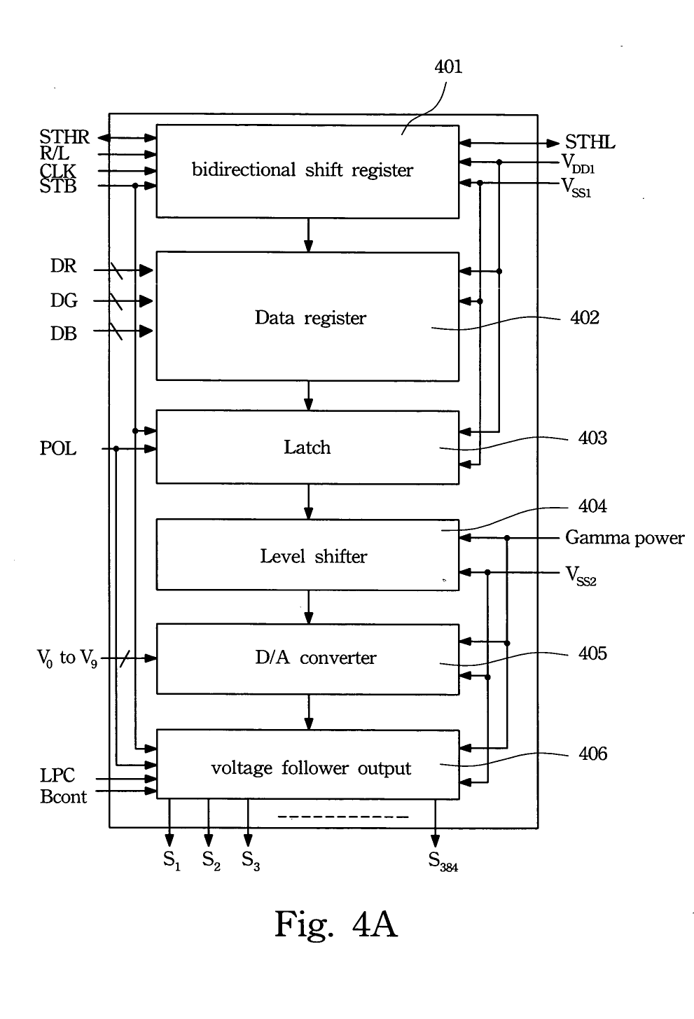

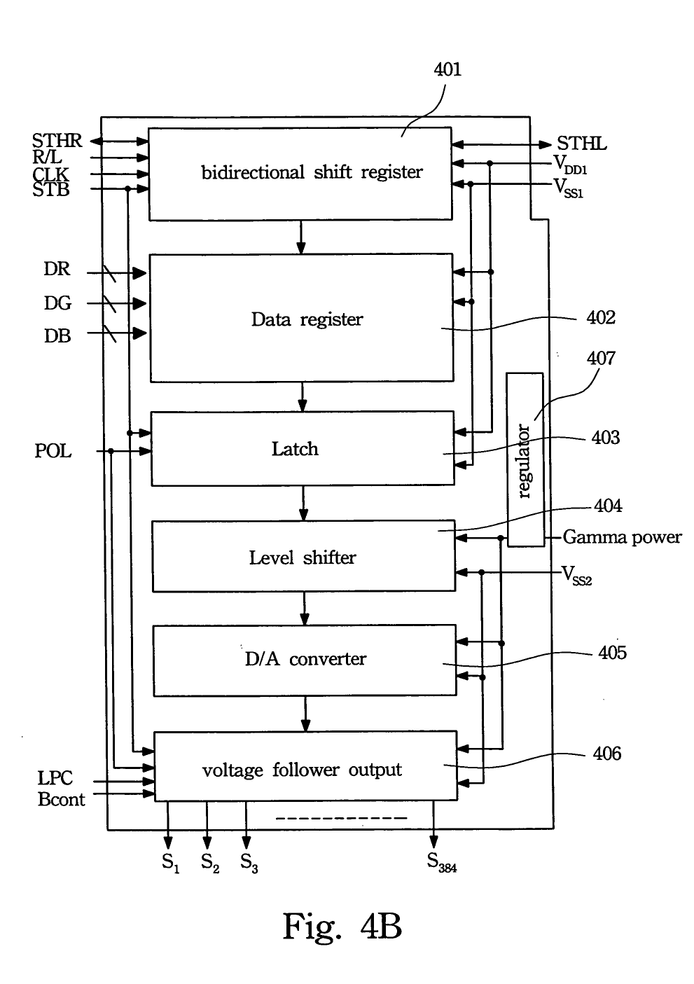

FIG. 4A illustrates a schematic diagram of a driver IC according to the preferred embodiment of the present invention, which comprises a bidirectional shift register 401, a data register 402, a latch 403, a level shifter 404, a D/A converter 405 and a voltage follower output 406. FIG. 4B illustrates a schematic diagram of a driver IC according to the preferred embodiment of the present invention. A constant voltage regulator 407 is assembled in the conventional driver IC to fix the output voltage in accordance with the present invention.

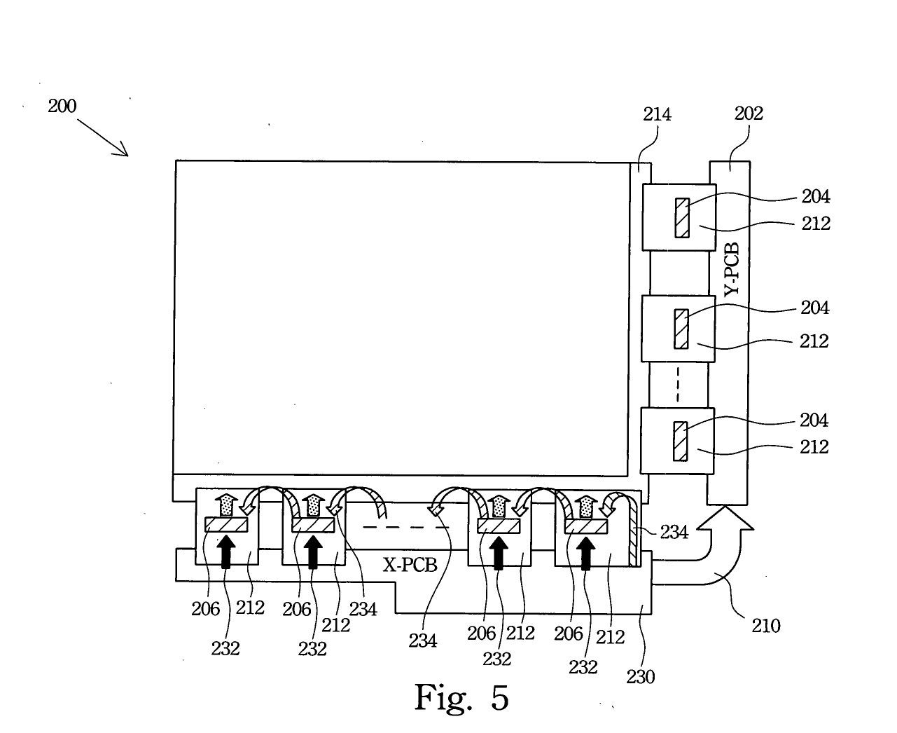

Besides the above-mentioned method, a second embodiment of the present invention also applies another method to solve power decay as shown in FIG. 5.

FIG. 5 illustrates a schematic diagram of a liquid crystal display according to the second embodiment of the present invention, which comprises a liquid crystal panel 200 located on a glass substrate 214 for displaying the image, Y-direction driver integrated circuit (IC) chips 204, X-direction driver integrated circuit (IC) chips 206, a Y-direction printed circuit board (Y-PCB) 202 and an X-direction printed circuit board (X-PCB) 230. The PCBs 202 and 230 are used to process the electrical signal. The driver IC chips 204 and 206 are located on a flexible printed circuit (FPC) 212. The FPC board 212 can be a tape carrier package (TCP) or a chip on film (COF). An another printed circuit board 210 is used to connect the PCBs 202 and 216. The another printed circuit board 210 is a flexible printed circuit film.

The conductive lines in the conventional structure are arranged in the X-direction PCB 108 as illustrated in the FIG. 1. However, according to the second embodiment of the present invention, the power lines are arranged between the X-direction PCB 230 and the X-direction driver integrated circuit (IC) chips 206. The signal lines are arranged in the FPC boards 212 and the glass substrate 214 as illustrated in the FIG. 5. Generally speaking, only the power lines are arranged in the X-direction PCB 230 in the second embodiment. Therefore, the area of the X-direction PCB 230 can be reduced. Moreover, the voltage difference can be avoided due to transferred through the glass substrate. Anisotropic conductive films (ACFs) are used for fine pitch interconnections between the liquid crystal panel 200, the FPC boards 212 and the glass substrate 214.

It is noticed that the conductive lines arrangement of the first and second embodiments also can be used in the Y-direction to reduce the whole volume of the liquid crystal display.

According to the second embodiment of the present inveniton shown in the FIG. 5, the power is transferred to the X-direction driver IC chips 206 from the X-direction PCB 230. In other words, each IC chip 206 independly receives the power from the X-direction PCB 230. Therefore, each IC chip 206 has an independent power line 232 coming from the X-direction PCB 230. The driving signal in the signal lines 234 in the X direction is generated from the X-direction PCB 230 at beginning. After that, the driving signal is cross one of X-direction FPC boards 212 with an extra part to the glass substrate 214. And then, the driving signal in the signal lines 234 in the X direction is sequentially transferred to the X-direction driver IC chips 206 for controlling an image display in the panel.

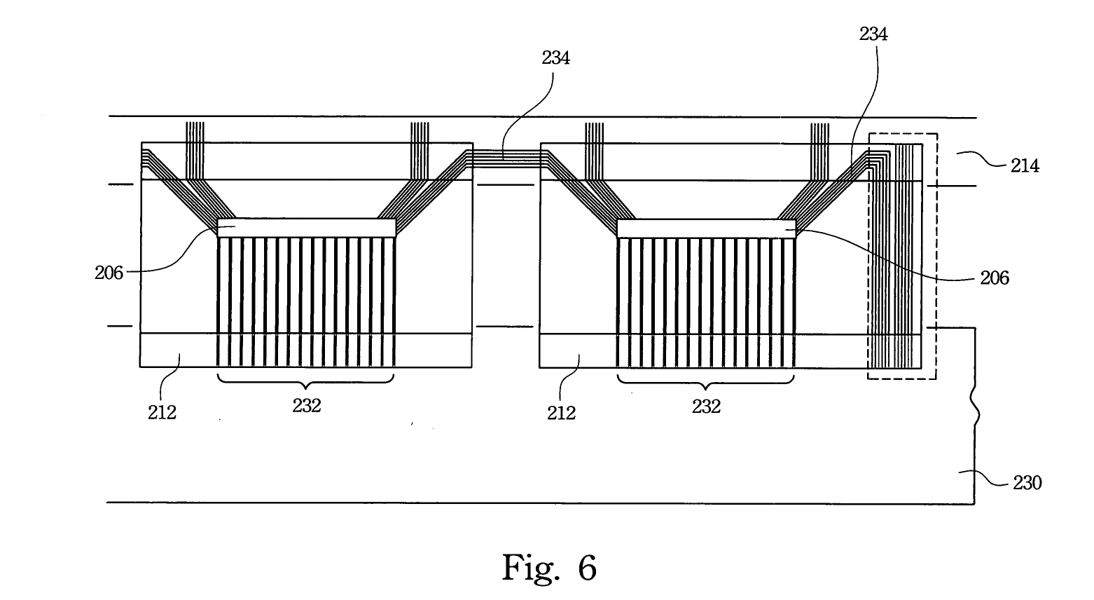

FIG. 6 illustrates a schematic diagram of the conductive line arrangement according to the second embodiment of the present invention. All power lines 232 are arranged in the X-direction PCB 230 for transferring power to the X-direction driver integrated circuit (IC) chips 206. The signal lines 234 are arranged in the FPC boards 212 and the glass substrate 214 for electrical connecting with the chips 206. In other words, the signal lines 234 are sequentially connected with each of the X-direction driver IC chips 206.

On the other hand, according to the conductive line structure of the present invention, the frame width of the glass substrate can be reduced by narrowing the distance between any two adjacent FPC boards. Some conductive lines of the present invention are arranged in the glass substrate. Typically, the glass substrate has a larger resistance. The solution is to enlarge the cross-sectional area of the conductive lines to reduce the resistance. However, a larger frame width of the glass substrate is required to accommodate these conductive lines. Therefore, in the present invention, the length of the conductive lines arranged in the glass substrate is reduced by narrowing the distance between any two adjacent FPC boards to reduce the power degradation due to the resistance of the glass substrate. In other words, the cross-section area of the conductive lines is not enlarged. Therefore, a narrow frame can be provided by the present invention.

According to the above description, the conductive lines transferring the power and signals are arranged on the FPC board and glass substrate to reduce the required PCB area in the present invention. Additionally, an additional regulator is added to a conventional driver IC for fixing an output voltage to avoid aliasing.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

1. A structure of a liquid crystal display, said structure comprising:
a panel with a upper and a lower substrate;
a plurality of first flexible printed circuit boards coupled to a side of said lower substrate;
a second flexible printed circuit board coupled to said side of said lower substrate next to said first flexible printed circuit boards;
a plurality of driver integrated circuit chips respectively arranged in said first flexible printed circuit boards; and
a signal source coupled with said second flexible printed circuit board for transferring a control signal and power to second flexible printed circuit board, and to said first flexible printed boards via said lower substrate.

2. The structure of claim 1, wherein said second flexible printed circuit board is attached with one of said first flexible printed circuit board.

3. The structure of claim 1, wherein said signal source further coupled with the plurality of first flexible printed circuit boards for transferring power.

4. The structure of claim 1, wherein said first flexible printed circuit board is a tape carrier package (TCP).

5. The structure of claim 1, wherein said first flexible printed circuit board is a chip on film (COF).

6. The structure of claim 1, wherein said second flexible printed circuit board is a flexible printed circuit film.

7. The structure of claim 1, wherein said signal source comprises a gamma power, a drain voltage (VDD) and a ground (GND).

8. The structure of claim 1, wherein said plurality of driver integrated circuit chips is arranged in series.

9. The structure of claim 1, wherein an anisotropic conductive film is used to connect electrically said panel, said first flexible printed circuit boards and said lower substrate.

10. The structure of claim 1, wherein said structure further comprises a plurality of regulator for fixing an output voltage from said plurality of driver integrated circuit chips.

11. The structure of claim 1, wherein said second flexible printed circuit board is adjacent to said first flexible printed circuit board.

12. The structure of claim 1, further comprising a first conductive line running on each of said first flexible printed circuit board and a second conductive line running on said substrate for connecting said first conductive lines.

13. The conductive line structure of claim 1, wherein said structure further comprises a plurality of regulator respectively located in said plurality of driver integrated circuit chips.

14. A structure of a liquid crystal display, said structure comprising:
a panel with a upper and a lower substrate;
a plurality of flexible printed circuit boards coupled to said lower substrate;
a plurality of integrated circuit chips respectively arranged in said flexible printed circuit boards;
a printed circuit board electrically coupled with said flexible printed circuit boards;
a first conductive line arranged between said printed circuit board and said flexible printed circuit boards for supplying power to said chips; and
a second conductive lines arranged on said lower substrate and electrically coupled with said flexible printed circuit board for transferring control signals to said chips.

15. The structure of claim 14, wherein said flexible printed circuit board is a tape carrier package (TCP).

16. The structure of claim 14, wherein said flexible printed circuit board is a chip on film (COF).

17. The structure of claim 14, wherein said plurality of driver integrated circuit chips is arranged in series.

18. A display substrate comprising:
a first conductive member attached to said substrate;
at least two chip carrying members each attached to said substrate and electrically coupled to said first conductive member;
a conductive line running on said substrate; and
a signal source, wherein a signal from said signal source is delevered to a chip carried by one of said chip carrying members via said first conductive member and said conductive line.

19. The display substrate of claim 18, wherein said first conductive member is a tape carrier package (TCP).

20. The display substrate of claim 18, wherein said first conductive member is a chip on film (COF).

21. The display substrate of claim 18, wherein an anisotropic conductive film is used to connect electrically said substrate, said first conductive member and said chip carrying members.

22. The structure of claim 18, wherein said first conductive member is attached with one of said chip carrier members.

23. The structure of claim 18, wherein said signal source further coupled with said chip carrier members for transferring power.

24. The structure of claim 18, wherein said chip carrier members is arranged in series.

25. The structure of claim 18, wherein said structure further comprises a plurality of regulator for fixing an output voltage from said chip carrier members.

26. The structure of claim 18, wherein said first conductive member is adjacent to said said chip carrier members.

27. The conductive line structure of claim 18, wherein said structure further comprises a plurality of regulator respectively located in said chip carrier members.
